(19) United States
(12) Patent Application Publication
(10) Pub. No.: US 2005/0078975 A1
(43) Pub. Date: Apr. 14, 2005

(54) Apparatus and method of controlling fixer

(76) Inventor: Young-min Chae, Suwon-si (KR)

Correspondence Address: STANZIONE & KIM, LLP, 1740 N STREET, N.W., FIRST FLOOR, WASHINGTON, DC, 20036, US

(21) Appl. No.: 10/921,996

(22) Filed: Aug. 20, 2004

(30) Foreign Application Priority Data
Oct. 10, 2003 (KR) 2003-70646

(51) Int. Cl. G03G 15/00

(52) U.S. Cl. 399/88

(57) ABSTRACT

An apparatus and method of controlling a fixer in an image forming apparatus includes an AC power source inputting unit to receive an external power source voltage signal, a synchronization signal generating device to generate a pulse signal synchronized with a peak of the power source voltage signal received from the AC power source inputting unit, and a controlling unit to control the pulse signal generated by the synchronization signal generating device so that a power source is supplied to the fixer.

### CROSS-REFERENCE TO RELATED APPLICATIONS

This application claims the priority of Korean Patent Application No. 2003-70646, filed on Oct. 10, 2003, in the Korean Intellectual Property Office, the disclosure of which is incorporated herein in its entirety by reference.

### BACKGROUND OF THE INVENTION

1. Field of the Invention

The present general inventive concept relates to an image forming apparatus, such as a printer or a copier, and more particularly, to an apparatus and method of controlling a fixer by generating a synchronous signal of a power source voltage, which is used to control power at the fixer to fix a toner image in an image forming apparatus.

2. Description of the Related Art

Generally, a fixer of an image forming apparatus, such as a laser printer, requires a large amount of heat to fix a toner image. An alternating current power is used to generate the large amount of heat. When the alternating current power is used, there is a drawback in that a high current flows to the fixer, thereby deteriorating a flicker characteristic. The flicker characteristic represents a phenomenon in which power supplied to a peripheral circuit is temporarily weakened.

A method of improving a flicker characteristic is disclosed in U.S. Pat. No. 6,240,263 entitled “FLICKER SUPPRESSION DEVICE IN ELECTRONIC EQUIPMENT.”

FIG. 1 illustrates a fixer and a device for supplying power to the fixer of a conventional image forming apparatus. The image forming apparatus includes a fixer 10, a fixer controlling unit 20, a main controlling unit 30 and a power source inputting unit 40. The fixer controlling unit 20 includes a Triac driving unit 22, a Triac switching unit 24 and a control signal receiving unit 26.

The main controlling unit 30 controls a temperature sensor (not shown) for detecting a temperature of the fixer 10 and outputs a control signal to the fixer controlling unit 20 when it is determined by checking a temperature of the fixer that the temperature must be elevated. The control signal receiving unit 26 receives the control signal from the main controlling unit 30. When the control signal is received, the Triac switching unit 24 performs a switching operation to supply an alternating current power from the power source inputting unit 40 to the fixer 10 through the Triac driving unit 22.

The Triac driving unit 22 turns-on a Triac at the time of zero crossing so as to improve a power factor and reduce a spike current. However, when there is no phase information of a power source voltage, the Triac can be irregularly turned on, and accordingly, the flicker characteristic cannot be improved. Further, it is essential that the power of the fixer 110 be instantaneously controlled so as to meet flicker standard requirements regulated by a variation rate of consumed power. In order to embody this instantaneous power control, information on a phase of the power source voltage is required. Further, since a high-speed large capacity laser printer or copier uses a large amount of thermal energy in the fixer 110, if the variation of consumed power is not minimized through the instantaneous power control, it is not easy to meet the flicker standard requirements.

Further, a device generating the synchronous signal of the power source voltage irrespective of the magnitude (110 or 220 volts) and the frequency (50 or 60 Hz) of the power source voltage inputted is required.

### SUMMARY OF THE INVENTION

In order to solve the foregoing and/or other problems, it is an aspect of the present general inventive concept to provide an apparatus to control a fixer by generating a synchronous signal to operate the fixer at a peak of a power source voltage irrespective of variations in magnitude and frequency of the power source voltage.

It is another aspect of the present general inventive concept to provide a method of controlling a fixer by generating a synchronous signal to operate the fixer at a peak of a power source voltage irrespective of variations in magnitude and frequency of the power source voltage.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an apparatus to control a fixer of an image forming apparatus, the apparatus including an AC power source inputting unit to receive an external power source voltage, a synchronization signal generating device to generate a pulse signal synchronized with a peak of the power source voltage received from the AC power source inputting unit, and a controlling unit to control a power source to supply power to the fixer according to the pulse signal generated by the synchronization signal generating device.

In another aspect of the present general inventive concept, there is provided a method of controlling a fixer of an image forming apparatus, the method including: receiving an external power source voltage, generating a pulse signal synchronized with a peak of the power source voltage, and controlling a power source to supply power to the fixer according to the pulse signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a fixer and a device for supplying a power source to the fixer in a conventional image forming apparatus;

FIG. 2 illustrates an image forming apparatus having an apparatus to control a fixer according to an embodiment of the present general inventive concept;

FIG. 3 illustrates a circuit diagram of the image forming apparatus of FIG. 2;

FIGS. 4A through 4F illustrate voltage waveforms of the circuit diagram of FIG. 3 when an inputted power source voltage is 220 volts;

FIGS. 5A through 5F illustrate voltage waveforms of the circuit diagram of FIG. 3 when an inputted power source voltage is 110 volts;

FIG. 6 is a flow chart illustrating a method of generating a synchronous signal of a power source voltage according to another embodiment of the present general inventive concept; and

FIG. 7 is a flow chart illustrating a synchronous signal generating operation of FIG. 6.

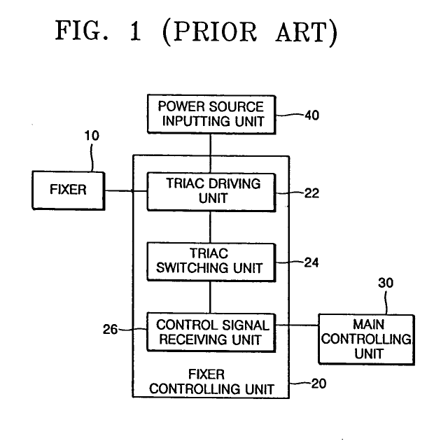

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

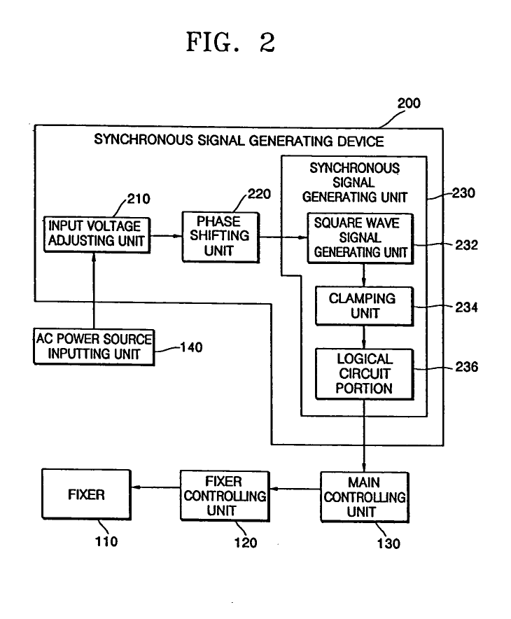

FIG. 2 illustrates an image forming apparatus including an apparatus to control a fixer according to an embodiment of the present general inventive concept.

As illustrated in FIG. 2, the image forming apparatus can include a fixer 110, a fixer controlling unit 120, a main controlling unit 130, an AC power source inputting unit 140, and a device 200 to generate a synchronous signal of a power source voltage signal. The device 200 can include an input voltage adjusting unit 210, a phase shifting unit 220 and a synchronous signal generating unit 230. The synchronous signal generating unit 230 can include a square wave signal generating unit 232, a clamping unit 234 and a logic circuit portion 236.

The device 200 can generate the synchronous signal of the power source voltage to control power of the fixer to fix a toner image in the image forming apparatus.

The AC power source inputting unit 140 can receive the power source voltage signal from an external source.

The input voltage adjusting unit 210 can adjust the power source voltage signal within a predetermined magnitude and can output the adjusted voltage signal to the phase shifting unit 220. The adjusted voltage signal within the predetermined magnitude (magnitude-adjusted signal) can be inputted to the phase shifting unit 220 having an operational amplifier (OP AMP), a logic circuit portion or the like, and the magnitude-adjusted signal can be, for example, 18 volts (V). The phase shifting unit 220 can phase-shift the magnitude-adjusted signal inputted from the input voltage adjusting unit 210 and outputs a phase-shifted signal to the synchronous signal generating unit 230.

For example, the phase shifting unit 220 can include a differential circuit using the operational amplifier (OP-AMP). When the differential circuit is used, the phase shifting unit 220 can output the phase-shifted signal lagging behind the magnitude-adjusted signal by 90 degrees. Meanwhile, the phase shifting unit 220 can include an integral circuit instead of the differential circuit. If the integral circuit is used, the phase shifting unit 220 can output a phase-shifted signal that leads the magnitude-adjusted signal by 90 degrees.

The synchronous signal generating unit 230 can combine the magnitude-adjusted signal inputted from the input voltage adjusting unit 210 with the phase-shifted signal inputted from the phase shifting unit 220 to output the synchronous signal of the power source voltage signal to the main controlling unit 130. The main controlling unit 130 can control the external source to supply power to the fixer 110 using the synchronous signal of the power source voltage signal.

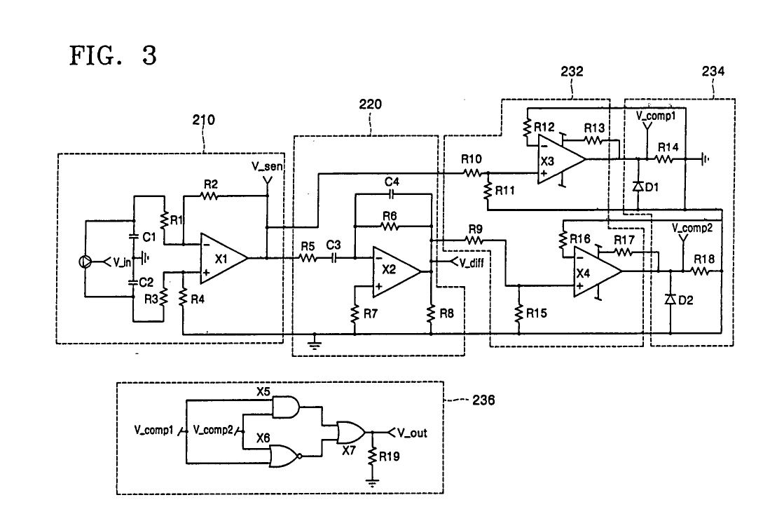

The square wave signal generating unit 232 can respectively convert the magnitude-adjusted signal and the phase-shifted signal into first and second square wave signals and outputs the first and second square wave signals to the clamping unit 234, respectively. The square wave signal generating unit 232 can include first and second comparators (X3 and X4 of FIG. 3). The first comparator X3 of the square wave signal generating unit 232 can convert the magnitude-adjusted signal into the first square wave signal, and the second comparator X4 of the square wave signal generating unit 232 can convert the phase-shifted signal into the second square wave signal.

The clamping unit 234 can clamp negative voltage signals of the first and second square wave signals, thereby converting the clamped signals into first and second positive square wave signals. The clamping unit 234 can include first and second diodes (D1 and D2 of FIG. 3). The first diode D1 of the clamping unit 234 can be used to clamp the first square wave signal, thereby converting the clamped signal into the first positive square wave signal, and the second diode D2 of the clamping unit 234 can be used to clamp the second square wave signal, thereby converting the clamped signal into the second positive square wave signal.

The logic circuit portion 236 can include one or more logic circuits to combine the first and second positive square wave signals inputted from the clamping unit 234, thereby outputting the synchronous signal of the power source voltage signal.

The synchronous signal of the power source voltage signal can be a pulse signal synchronized to a power source voltage peak of the power source voltage signal. That is, the present general inventive concept can provide a circuit to output the pulse signal as the synchronous signal synchronized to the power source voltage peak.

The synchronous signal can be used to control a switching unit used in the fixer controlling unit 120 to perform a switching operation. For example, a thyristor, a SCR (Silicon Controlled Rectifier), a Triac, an IGBT (Insulated Gate Bipolar Transistor) and a MOSFET are used as the switching unit. That is, when the pulse signal synchronized to the power source voltage peak is used to control the switching unit, such as the Triac, to perform the switching operation, the switching unit can perform a turn-on operation at the time of a desired zero-crossing point.

FIG. 3 illustrates a circuit diagram of an apparatus to control a fixer in an image forming apparatus according to another embodiment of the present general inventive concept.

As illustrated in FIGS. 2 and 3, if the phase shifting unit 220 includes the differential circuit, the logic circuit portion 236 can include three logic circuits: a logical product (AND) circuit (X5), a non-disjunction (NOR) circuit (X6) and a logical sum (OR) circuit (X7). The first positive square wave signal and the second positive square wave signal can be inputted to the AND circuit (X5) and the NOR circuit (X6). Outputs of the AND circuit (X5) and the NOR circuit (X6) can be inputted to the OR circuit (X7), and an output of the OR circuit (X7) can be the pulse signal synchronized to the power source voltage peak.

In a case where the phase shifting unit 220 includes the integral circuit, the logical circuit portion 236 can include an exclusive OR (XOR) circuit. An output of the XOR circuit can be the pulse signal synchronized to the power source voltage peak.

Additional descriptions for the circuit diagram of FIG. 3 are omitted for simplicity since each operation of each element of the circuit diagram of FIG. 3 is well-known.

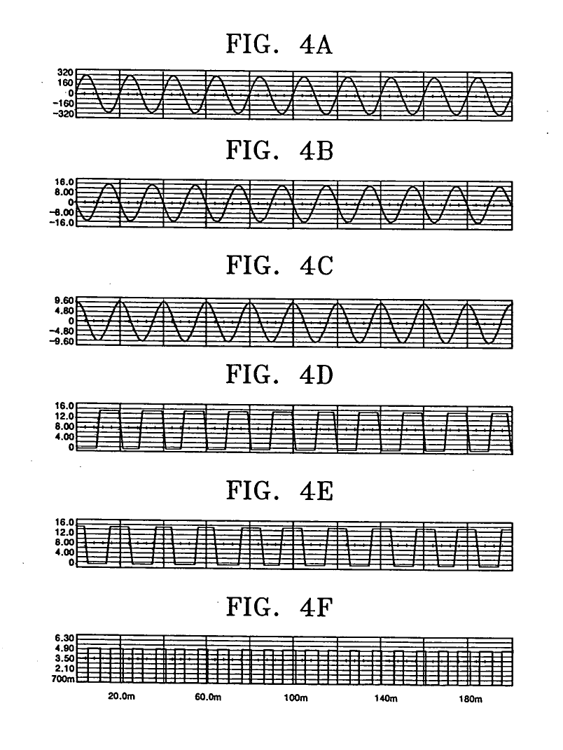

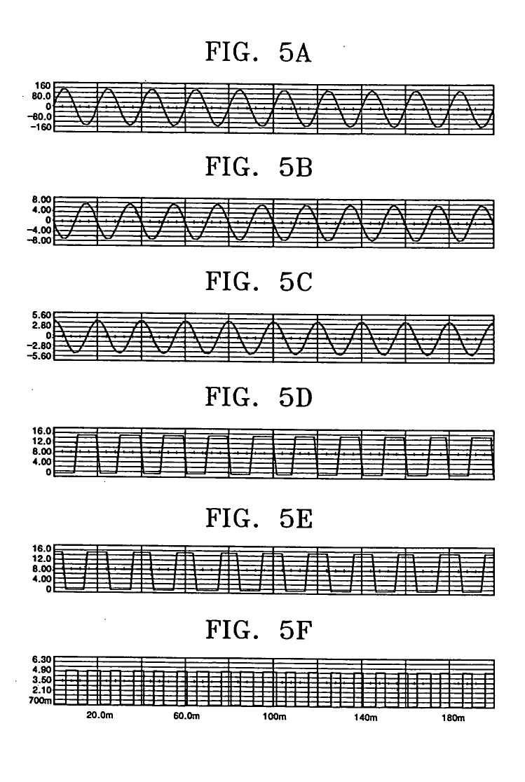

FIGS. 4A through 4F illustrate voltage waveforms of the circuit diagram of FIG. 3 when the inputted power source voltage signal is 220 volts, and FIGS. 5A through 5F illustrate voltage waveforms of the circuit diagram of FIG. 3 when the inputted power source voltage signal is 110 volts. Here, an X-axis represents time (second), and a Y-axis represents voltage (V).

FIGS. 4A and 5A illustrate signal waveforms (V_in of FIG. 3) of the power source voltage signals inputted to the input voltage adjusting unit 210, and FIGS. 4B and 5B illustrate waveforms (V_sen of FIG. 3) of the magnitude-adjusted signals outputted from the input voltage adjusting unit 210. FIGS. 4C and 5C illustrate waveforms of the phase-shifted signals lagging behind the magnitude-adjusted signals by 90 degrees, as signal waveforms (V_diff of FIG. 3) outputted from the phase shifting unit 220. FIGS. 4D and 5D illustrate waveforms (V_comp1 of FIG. 3) of the first square wave signals outputted from the first comparator X3. FIGS. 4E and 5E illustrate waveforms (V_comp2 of FIG. 3) of the second square wave signals outputted from the second comparator X4. FIGS. 4F and 5F illustrate waveforms (V_out of FIG. 3) of the synchronous signals of the power source voltage signals outputted from the logical circuit portion 236.

It can be understood that the synchronous signals illustrated in FIGS. 4F and 5F are synchronized to peaks of the power source voltage signals illustrated in FIGS. 4A and 5A. Further, it can be understood that the power source voltage signal of 220 volts illustrated in FIG. 4A is different from the power source voltage signal of 110 volts illustrated in FIG. 5A, but as results of processing the power source voltage signals, output waveforms of FIGS. 4F and 5F are identical with each other. As such, it can be understood that the device 200 to generate the synchronous signal of the power source voltage signal can be operable regardless of the magnitude of the power source voltage signal inputted. Those skilled in the art shall understand that the above embodiment exemplifies the power source voltage signal of 220 volts and 110 volts, but the same results can be obtained even at a power source voltage signal between 110 volts and 220 volts, a power source voltage signal less than 110 volts, and a power source voltage more than 220 volts.

In the meantime, those skilled in the art shall understand that FIGS. 4A through 4F and FIGS. 5A through 5F illustrate the waveforms of the power source voltage signals having frequencies of 50 Hz, but an output signal of a power source voltage signal with a frequency of 60 Hz can also be the pulse signal synchronized to the power source voltage peak. Further, those skilled in the art shall understand that output signals of power source voltage signals with a frequency between 50 Hz and 60 Hz, a frequency less than 50 Hz and a frequency more than 60 Hz, are the pulse signals synchronized to the power source voltage peaks.

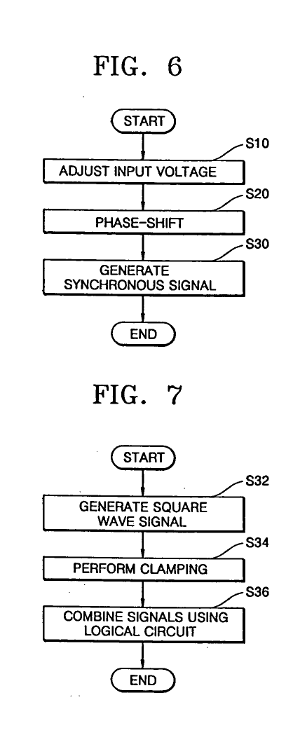

FIG. 6 is a flow chart illustrating a method of generating a synchronous signal of a power source voltage signal according to another embodiment of the present general inventive concept, and FIG. 7 is a flow chart illustrating a synchronous signal generating operation S30 of FIG. 6.

Referring to FIGS. 6 and 7, the method of controlling a fixer of an image forming apparatus to generate the synchronous signal can include receiving a power source voltage signal from an external source, generating a pulse signal synchronized with a peak of the received power supply voltage signal, and controlling the pulse signal so that a power source is supplied to the fixer. The generating operation can include adjusting the received power source voltage signal within the predetermined magnitude and outputting the adjusted voltage signal (S10), phase-shifting the magnitude-adjusted signal and outputting the phase-shifted signal (S20), and generating the pulse signal synchronized with the peak of the power source voltage signal by combining the magnitude-adjusted signal and the phase-shifted signal to output the synchronous signal of the power source voltage signal (S30). The voltage signal with the predetermined magnitude can be the voltage signal inputted to the control circuit such as the operational amplifier (OP AMP), the logical circuit or the like, and is, for example, 18 volts (V).

The synchronous signal generating operation (S30) can include square wave signal generating operation (S32) of respectively converting the magnitude-adjusted signal and the phase-shifted signal into the first and second square wave signals and outputting the first and second square wave signals. In the square wave signal generating operation (S32), the first comparator (X3 of FIG. 3) can be used to convert the magnitude-adjusted signal into the first square wave signal, and the second comparator (X4 of FIG. 3) can be used to convert the phase-shifted signal into the second square wave signal.

Further, the synchronous signal generating operation (S30) can additionally include clamping negative voltage signals of the first and second square wave signals to convert the clamped signals into the first and second positive square wave signals. In the clamping operation (S34), the first diode (D1 of FIG. 3) can be used to clamp the first square wave signal, thereby converting the clamped signal into the first positive square wave signal, and the second diode (D2 of FIG. 3) can be used to clamp the second square wave signal, thereby converting the clamped signal into the second positive square wave signal.

Further, in the synchronous signal generating operation (S30), the logical circuit portion (236) of FIG. 3 can be used to combine the first and second positive square wave signals, thereby outputting the synchronous signal of the power source voltage signal. The synchronous signal of the power source voltage signal can be the pulse signal synchronized to the power source voltage peak.

In the phase shifting operation (S20), the differential circuit having the OP-AMP (X2 of FIG. 3) can be used to output the phase-shifted signal that lags behind the magnitude-adjusted signal by 90 degrees. Further, in a case where the integral circuit is used in the phase shifting operation (S20), the phase-shifted signal that leads the magnitude-adjusted signal by 90 degrees is outputted.

As described above, in an aspect of the present general inventive concept, the fixer controlling apparatus can output the synchronous signal of the power source voltage signal at the peak of the alternating current power signal irrespective of the variations in magnitude and frequency of the power source voltage signal and can effectively switch the Triac or the SCR of the fixer using the synchronous signal, it can improve a power factor of a driving circuit of the fixer and a flicker characteristic and can control an instantaneous power.

In another aspect of the present general inventive concept, since the fixer controlling apparatus can detect the synchronous signal of the power source voltage signal irrespective of variations in magnitude and frequency of the power source voltage signal, it can be applied to all worldwide copiers or printers using power sources having different voltage magnitudes and frequencies.

In yet another aspect of present general inventive concept, since only several ICs (Integrated Circuits) are additionally used, a circuit construction of the fixer controlling apparatus can be embodied at a low cost.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to control a fixer of an image forming apparatus connected to a power source, comprising:
an AC power source inputting unit to receive an external power source voltage signal;
a synchronization signal generating device to generate a pulse signal synchronized with a peak of the power source voltage signal received from the AC power source inputting unit; and
a controlling unit to control a power source to supply power to the fixer according to the pulse signal generated by the synchronization signal generating device.

2. The apparatus of claim 1, wherein the synchronization signal generating device comprises:
an input voltage adjusting unit which adjusts the power source voltage signal received from the AC power source inputting unit within a predetermined magnitude and outputs the magnitude-adjusted voltage signal;
a phase shifting unit which phase-shifts the magnitude-adjusted signal inputted from the input voltage adjusting unit and outputs the phase-shifted signal; and
a synchronous signal generating unit which combines the magnitude-adjusted signal inputted from the input voltage adjusting unit with the phase-shifted signal inputted from the phase shifting unit to generate the pulse signal synchronized with the peak of the power source voltage signal.

3. The apparatus of claim 2, wherein the synchronous signal generating unit comprises a square wave signal generating unit which respectively converts the magnitude-adjusted signal and the phase-shifted signal into first and second square wave signals and outputs the first and second square wave signals.

4. The apparatus of claim 3, wherein the square wave signal generating unit comprises first and second comparators to convert the magnitude-adjusted signal into the first square wave signal and the phase-shifted signal into the second square wave signal, respectively.

5. The apparatus of claim 4, wherein the synchronous signal generating unit further comprises a clamping unit which clamps negative voltages of the first and second square wave signals to convert the clamped signals into first and second positive square wave signals.

6. The apparatus of claim 5, wherein the clamping unit comprises first and second diodes to clamp the first square wave signal into the first positive square wave signal and the second square wave signal into the second positive square wave signal, respectively.

7. The apparatus of claim 5, wherein the synchronous signal generating unit further comprises a logical circuit portion having one or more logical circuits to combine the first and second positive square wave signals inputted from the clamping unit using the one or more logical circuits to output the synchronous signal of the power source voltage signal.

8. The apparatus of claim 2, wherein the phase shifting unit comprises a differential circuit to output the phase-shifted signal that lags behind the magnitude-adjusted signal by 90 degrees.

9. The apparatus of claim 2, wherein the phase shifting unit comprises an integral circuit to output the phase-shifted signal that leads the magnitude-adjusted signal by 90 degrees.

10. The apparatus of claim 2, wherein the phase shifting unit comprises at least one of an operational amplifier (OP-AMP) and a logical circuit, and the input voltage adjusting unit adjusts the externally inputted power source voltage signal within the magnitude so that the operational amplifier (OP-AMP) or the logical circuit is operable with the magnitude-adjusted signal.

11. A method of controlling a fixer of an image forming apparatus, the method comprising:
receiving an external power source voltage signal;
generating a pulse signal synchronized with a peak of the power source voltage signal; and
controlling a power source to supply power to the fixer according to the pulse signal.

12. The method of claim 11, the generating of the synchronized pulse signal comprises:
adjusting the received power source voltage signal within a predetermined magnitude, and outputting the magnitude-adjusted voltage signal;
phase-shifting the magnitude-adjusted voltage signal and outputting the phase-shifted signal; and
generating the pulse signal synchronized with the peak of the power source voltage signal by combining the magnitude-adjusted signal with the phase-shifted signal.

13. The method of claim 12, wherein the generating of the synchronized pulse signal further comprises converting the magnitude-adjusted signal and the phase-shifted signal into first and second square wave signals, respectively, and outputting the first and second square wave signals.

14. The method of claim 13, wherein in the generating of the first and second square wave signals comprises converting the magnitude-adjusted signal into the first square wave signal using a first comparator, and converting the phase-shifted signal into the second square wave signal using a second comparator.

15. The method of claim 14, wherein the generating of the synchronized pulse signal further comprises clamping negative voltages of the first and second square wave signals to convert the clamped signals into first and second positive square wave signals.

16. The method of claim 15, wherein the claming of the negative voltages of the first and second square wave signals comprises clamping the first square wave signal to be converted into the first positive square wave signal using a first diode, and clamping the second square wave signal to be converted into the second positive square wave signal using a second diode.

17. The method of claim 15, wherein the generating of the synchronized pulse signal comprises combining the first and second positive square wave signals using a logical circuit and outputting the synchronous signal of the power source voltage signal.

18. The method of claim 12, wherein the phase shifting of the magnitude-adjust voltage signal comprises outputting the phase-shifted signal that lags behind the magnitude-adjusted signal by 90 degrees, using a differential circuit.

19. The method of claim 12, wherein the phase shifting of the magnitude-adjusted voltage signal comprises outputting the phase-shifted signal that leads the magnitude-adjusted signal by 90 degrees, using an integrated circuit.

20. The method of claim 12, wherein the adjusting of the power source voltage signal comprises adjusting the externally inputted power source voltage signal within the magnitude so that an operational amplifier (OP-AMP) or a logical circuit is operable to phase-shift the magnitude-adjusted signal.
